(19) United States
(12) Patent Application Publication
(10) Pub. No.: US 2021/0100410 A1
(43) Pub. Date: Apr. 8, 2021

(54) Toilet-mounted electrical device created to extract and eliminate the bad odor produced by human flatulence and feces by ignition.

(71) Applicants: Carlos Manuel Poventud-Estrada, Fort Bragg, NC (US); Paola Aliene Escoriaza-Santana, Fort Bragg, NC (US)

(72) Inventors: Carlos Manuel Poventud-Estrada, Fort Bragg, NC (US); Paola Aliene Escoriaza-Santana, Fort Bragg, NC (US)

(21) Appl. No.: 16/594,006

(22) Filed: Oct. 5, 2019

(51) Int. Cl. A47K 11/02; F23G 5/10

(52) U.S. Cl. CPC A47K 11/023; F23G 5/10

(57) ABSTRACT

Toilet-mounted electrical device created to extract and eliminate via ignition the gases from the toilet bowl that generate the bad odor coming from human flatulence and feces.

### CROSS-REFERENCE TO RELATED APPLICATIONS

Not applicable.

### STATEMENT OF FEDERALLY SPONSORED RESEARCH OR DEVELOPMENT

Not applicable.

### THE NAMES OF THE PARTIES TO A JOINT RESEARCH AGREEMENT IF THE CLAIMED INVENTION WAS MADE AS A RESULT OF ACTIVITIES WITHIN THE SCOPE OF A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

Human flatulence and feces can generate gases with characteristic disagreeable odors (e.g. H₂S, C₂H₆S, etc.). Remedies to eliminate this stench vary from lighting a match or candle to chemical solutions for the toilet or aerosols. We filed patent application Ser. No. 16/152,957 on Oct. 5, 2018 for a portable electronic device designed and built for the purpose of eliminating these gases by ignition. This new patent application is for a toilet-mounted electrical device based on the same concepts of eliminating the gases by ignition.

### FIELD OF THE INVENTION

Small home electrical appliance to be used in the bathroom.

### BRIEF SUMMARY OF THE INVENTION

A toilet-mounted device (shown in FIG. 1) created to extract and eliminate via ignition the gases from the toilet bowl that generate the bad odor coming from human flatulence and feces.

### BRIEF DESCRIPTION OF THE SEVERAL VIEWS OF THE DRAWING

There are four figures in the Drawings annex:

FIG. 1 Schematic representation of the device mounted on the toilet.

FIG. 2 One line diagram of the device;

FIG. 3 Schematic representation of the device; and

FIG. 4 Drawing of the Ignition Chamber Brick (ICB).

### LEGEND AND SPECIFICATIONS (DESCRIPTION) FOR THE DRAWINGS

\textcircled{1} Metal enclosure

\textcircled{2} Extraction tube (e.g. vinyl tube)

\textcircled{3} Hanging chain

\textcircled{4} On/Off/Timer switch with indicating light

\textcircled{5} Wall plug with cable

\textcircled{6} Electrical cable to On/Off/Timer switch

\textcircled{7} Vacuum pump

\textcircled{8} Expulsion tube (e.g. vinyl tube)

\textcircled{9} Ignition Chamber Brick

\textcircled{10} Filament (e.g. Kanthal A-1 wire, 20gauge, coiled inside the ICB)

\textcircled{11} Copper tubing

\textcircled{12} Power supply

\textcircled{13} Vent-hole in enclosure

\textcircled{14} Ignition Chamber

\textcircled{15} Side-holes

### DETAILED DESCRIPTION OF THE INVENTION

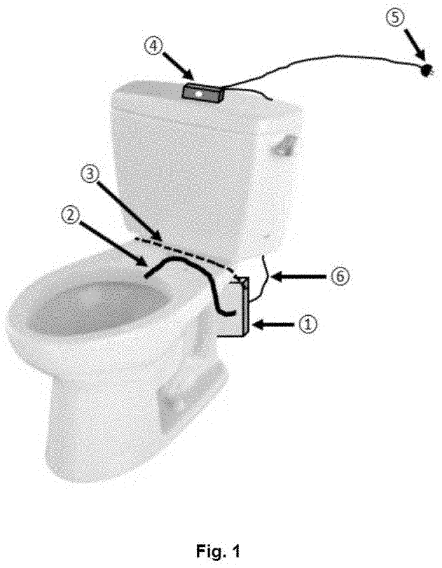

The device is enclosed within a metal enclosure \textcircled{1} with the following peripherals: Extraction tube \textcircled{2}, Hanging Chain \textcircled{3} On/Off/Timer switch with indicating light \textcircled{4} Wall plug with cable \textcircled{5}, and electrical cable to the On/Off/Timer switch \textcircled{6} as depicted in FIG. 1 to 3.

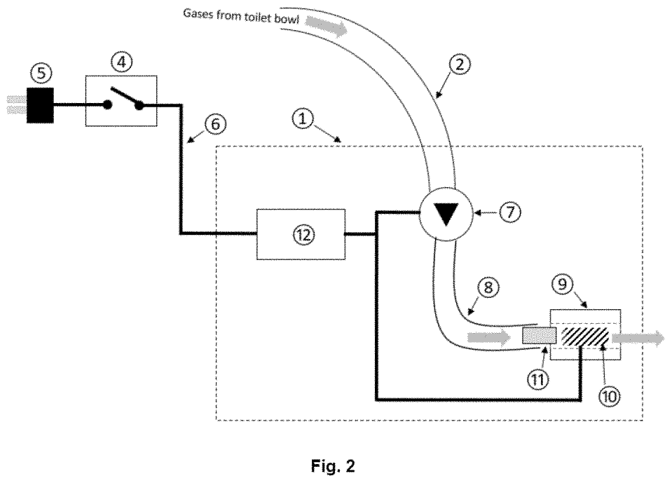

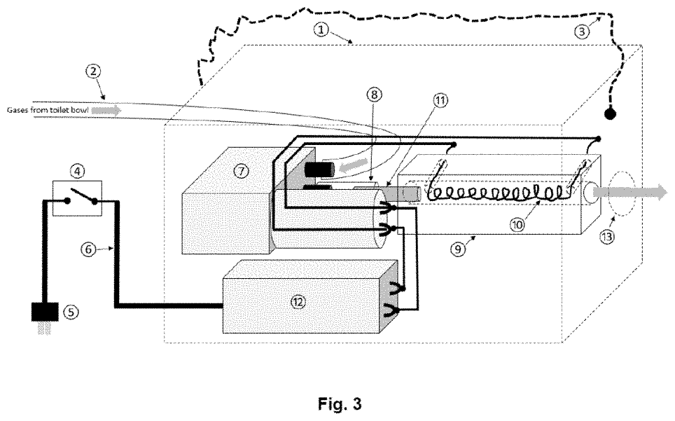

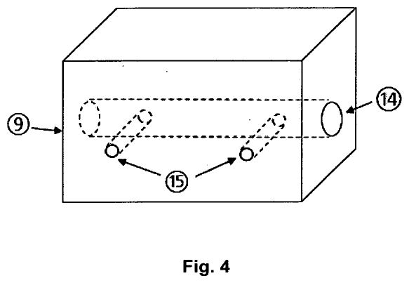

The device is powered from the Wall plug \textcircled{5} through an On/Off/Timer switch \textcircled{4} to a Power supply \textcircled{12}, which in turn feeds a Vacuum pump \textcircled{7} and Filament \textcircled{10} as shown in FIGS. 2 and 3. Mechanically, the device extracts the gases from the toilet bowl via the Extraction tube \textcircled{2}, through the Vacuum pump \textcircled{7} to the Expulsion tube \textcircled{8}, to the Copper tubing \textcircled{11} which is inserted into the Ignition Chamber Brick (ICB) \textcircled{9} as shown in FIGS. 2 and 3. The ICB \textcircled{9} is a rectangular block made of day-bearing soil, sand, lime or concrete materials with an Ignition Chamber \textcircled{14} across it to accommodate the Filament \textcircled{10} and two side-holes \textcircled{15} for Filament entry/exit as shown in FIG. 4. The Filament \textcircled{10} once energized will heat up and, reach a preset operational temperature to ignite the gases.

### MODE OF OPERATION OF THE INVENTION

The device is to be mounted on a toilet (i.e. hanging towards the back of the toilet via a Hanging chain \textcircled{3} as shown in FIG. 1 or sitting on the floor beside or behind the toilet). The user must insert the Extraction tube \textcircled{2} into the toilet bowl and place the On/Off/Timer switch \textcircled{4} on top of the toilet tank or close to the toilet and plug it to a wall receptacle as depicted in FIG. 1. The device is ready for use. Upon turning the device ON, the user will know it's operational by an indicating light on the On/Off/Timer switch \textcircled{4} and the sound of the Vacuum pump \textcircled{7}. The user can manually turn it OFF at any time or can leave the device ON until it automatically shuts OFF after a preset time period (e.g. 3 to 4 minutes). When the preset time period expires, the device is not operating (i.e. Vacuum pump \textcircled{7} and Filament \textcircled{10} are both OFF). If the device is turned ON again, a new cycle of the preset time period will start.

We claim:

1. A toilet-mounted electrical device created to extract and eliminate, via ignition, the gases from the toilet bowl that generate the bad odor coming from human flatulence and feces, said system comprising:
a Metal enclosure;
a Hanging chain;
a Wall plug with cable;
an On/Off/Timer switch with indicating light;
an Extraction tube;
a Vacuum pump;
an Expulsion tube;
a Copper tubing;
a Filament;
an Ignition Chamber Brick;
and a Power supply.

2. The system of claim 1, wherein said ignition Chamber Brick member is formed from clay-bearing soil, sand, lime or concrete materials with a chamber across it to accommodate the heating Filament and two side-holes for Filament entry/exit that can safely withstand temperatures that will ignite the passing gases.
